(19) United States
(12) Patent Application Publication
(10) Pub. No.: US 2014/0338267 A1
(43) Pub. Date: Nov. 20, 2014

(54) Multiple Hollow Bulb Seal

(71) Applicant: ULTRAFAB, INC., Farmington, NY (US)

(72) Inventor: Alan J. DeMello, Newmarket, NH (US)

(73) Assignee: ULTRAFAB, INC., Farmington, NY (US)

(21) Appl. No.: 14/450,892

(22) Filed: Aug. 4, 2014

Related U.S. Application Data
(62) Division of application No. 13/447,827, filed on Apr. 16, 2012.
(60) Provisional application No. 61/475,755, filed on Apr. 15, 2011.

(51) Int. Cl. E06B 7/23

(52) U.S. Cl. CPC E06B 7/2309; E06B 7/2314
USPC 49/498.1

(57) ABSTRACT

A seal for use in a fenestration system including: a seal base; an elongated, resilient bulb member defining a longitudinal direction and a transverse direction; wherein: the stem portion of the seal base and the resilient bulb member are rigidly directly mechanically connected to each other; the bulb member includes an exterior bulb wall with an interior surface, a first interior wall, and a second interior wall; the exterior bulb wall defines an interior space; the first interior wall and the second interior wall separate and at least partially define a first chamber, a second chamber, and a third chamber within the interior space of the exterior bulb wall.

### RELATED APPLICATION

The present application claims priority to U.S. non-provisional patent Ser. No. 13/447,827, filed on Apr. 16, 2012, which is a non-provisional of U.S. provisional patent application number 61/475755, filed on 15 Apr. 2011; all of the foregoing patent-related document(s) are hereby incorporated by reference herein in their respective entirety(ies).

### BACKGROUND OF THE INVENTION

1. Field of the Invention

The present invention relates to weatherseals for fenestrations and more particularly to compressible bulb type weatherseals for fenestrations.

2. Description of the Related Art

Weatherseals (sometimes simply referred to as “seals” herein) are used in fenestration products (see DEFINITIONS section). Fenestration products are products like windows and doors that provide an openable closure in some type of wall, such as the wall of a house or the wall of a vehicle. The seal seals the interface between the fenestration frame and the fenestration closure member(s) (that is, the door(s) or window(s)). The seal can be present on the fenestration frame or the fenestration closure member or both. Herein, the fenestration structure (that is, frame or closure member) that has the seal “permanently” attached to it will be referred to as the seal-bearing fenestration structure. Herein, the fenestration structure (that is, frame or closure member) that engages the seal only when the fenestration is in the closed position, and releases the seal when the fenestration is moved to the open position, will be referred to as the seal-receiving fenestration structure. In this context, when it is stated that the seal is “permanently” attached to the seal-bearing member, it does not mean that these parts can never be detached without destroying the hardware, but only that the seal and the seal-bearing fenestration are not detached from each other during normal opening and closing operations of the door, window or other fenestration.

Weatherseals are generally characterized by performance characteristics including the following: (i) compression set resistance (that is, loss of functional height over use cycles and/or time); (ii) thermal properties (R value); (iii) sound abatement (STC/OTC); (iv) ability to withstand degradation due to environmental elements (including UV light); (v) ability to reduce or eliminate air infiltration; (vi) ability to reduce or eliminate water infiltration; and/or (vii) ability to maintain overall long term resiliency against permanent deformation.

Currently in the market are a wide range of seals. Some known seals use cost effective pile (that is, a textile based bundle of vertical fibers) to provide sealing and to allow window sashes to slide easily when operated by the dwelling occupant.

Other known seals use a compressible, hollow bulb to releasably seal the physical interface between the fenestration frame and the fenestration member. One example of a compressible bulb seal is an extruded thermal plastic elastomer (TPE) bulb seals. Compressible hollow bulb seals are conventionally designed to especially improve seal performance with respect to the performance characteristics of reduction of air and water infiltration. This is because the geometry of the bulb (as opposed to the geometry pile) provides continuous contact of the increased surface area formed by the compressed bulb when the window or door is in the closed position. Also, the compressive force across the contacting surface area may be higher with a bulb type seal than with a pile type seal. These conventional compressible hollow bulb seals can also offer solid UV resistance and low closing forces. On the other hand, as relative disadvantages, it is known that conventional compressible hollow bulb type seals: (i) can lose functional height due to compression set over time; (ii) have relatively unfavorable thermal properties; and (ii) have relatively unfavorable sound abatement properties.

These previously recognized performance shortcomings of compressible hollow bulb type seals has lead to the introduction of compressible bulb type seals that are filled with foam (herein called foam-filled compressible bulb type seals). Two types of foam-filled bulb seals are thermoplastic foam-filled bulb seals and thermoset foam-filled bulb seals. These two types will now be discussed.

Thermoplastic elastomer foams are typically made from a matrix of polypropylene and a small particles of thermoset rubber. Thermoplastic elastomer based foam seals offer solid results in all performance areas listed above, including having favorable long term resiliency to combat loss of functional height. Thermoplastic foam-filled bulb seals also typically have an extruded covering to improve the durability of foam. Through the use of a crosshead extrusion die this extruded covering is what attaches the foam to the seal base (with the seal base being the portion of the seal that is permanently attached to the seal-bearing fenestration structure). An example of a seal base is the extruded polypropylene t-slot backing used on pile seals, bulb seals or foamed bulb seals. More particularly, these t-slot backing type seal bases are inserted into a retention groove built into a seal-bearing fenestration structure.

A thermoset foam-filled type seal typically utilizes a rubber-based material. Typically, the seal becomes cured and takes a permanent physical structure through the use of: (i) chemical reactions (urethane foam); (ii) salt baths; and/or (iii) infrared radiation (for example, EPDM foam). Because the thermoset foam-filled bulb seal has foam that is set, this results in a seal that takes minimal compression set and outperform thermoplastic foam-filled bulb seals. Thermoset seals can also foamed very consistently to low densities as compared to inconsistent low densities achieved with thermoplastic foams.

### BRIEF SUMMARY OF THE INVENTION

Before proceeding to the seals of the present invention, it is first noted that the present inventions recognizes some drawbacks of conventional thermoplastic foam-filled bulb seals and conventional thermoset foam-filled bulb seals, which drawbacks will now be discussed.

The present invention recognizes that one drawback to thermoplastic foam-filled bulb seals is the fact that the foam used is difficult to foam consistently at lower densities (which lower densities are helpful for achieving a lower closing force performance characteristic). The present invention further recognizes thermoplastic foam-filled bulb seals have a thermoplastic covering that can cause a degree of friction that makes the seal undesirable, or even inoperative, for sliding applications. The present invention further recognizes that although foamed thermoplastic elastomer seals have generally favorable solid compression set resistance performance, they are still made from thermoplastic materials that, over time, will take a set and thereby lose some of their functional height. Also, closed cell foam filled seal windows tend to have a higher closing force and are therefore less convenient to operate.

The present invention recognizes that thermoset foam-filled bulb seals do not easily allow for a covering to be formed by current cross head extrusion processes. Also, some thermoset foam-filled bulb seal products now on the market (primarily, the non-urethane ones) utilize a low friction clad material that requires extraneous adhesives to secure the foam to the seal base. With respect to urethane foam thermoset foam-filled bulb seals, the present invention recognizes that one of the biggest drawbacks is the fact that urethane foam seals are created using an open celled foam structure that naturally absorbs water which is a substantial drawback especially in freeze thaw climates found throughout the world.

The present invention recognizes further subtle potential problems that foam filled bulbs may have. One of these problems is that the foam-filled seal may not only be compressed when opening or closing the window, but portions of this seal may also be compressed when the window is manipulated for cleaning operations. For example, some residential windows: (i) slide open and shut in the vertical direction during normal use; and (ii) can rotate within the frame for cleaning (so that the user can reach the outer surfaces of the window). However, during this rotation of the window, there is (by design) some physical interference between the seal and inward facing protrusions built into the lateral sides of the frame. This interference causes compression over small lengths of the seal. While this interference is relatively infrequent and relatively temporary, it may cause substantially more compression in affected areas of the seal than does the normal closing operation of the window. This cleaning-operation-compression can cause problems with foam filled seals, such as tearing of the cladding or difficulty performing the movement of the window for the cleaning operation. Also, some seals extend around 90 degree sharp corners. This can be difficult to achieve with foam filled seals, and even hollow bulb seals have a tendency to collapse and/or kink as they run around a corner.

At least some aspects of the present invention are directed to a seal that includes a hollow bulb that defines an interior space, and further includes at least one solid divider wall located in the interior space in order to divide the interior space so that it includes at least a first chamber and a second chamber, where the first and second chambers are not in fluid communication with one another. In some preferred embodiments: (i) the interior wall is generally V-Shaped in transverse cross-section; (ii) the first chamber is generally triangular in transverse cross-section; and (iii) the second chamber is generally U-shaped in transverse cross-section. Some preferred embodiments further include a seal base (for example, a T-shaped base), with the hollow bulb being mechanically connected to the base at the bottom of the T-shape so that an open end of the V-shaped interior wall is oriented to directly face the seal base. In some preferred embodiments, the first and second chambers are hollow, but there may be embodiments of the present invention where the first and second chambers are filled with foam, or fluid or fibers, etc.

At least some aspects of the present invention are directed to weatherseal that is a lower cost alternative to foam-filled bulb seals (thermoset and thermoplastic). At least some aspects of the present and also meets or exceeds the performance of all seal options described above with respect to the performance characteristics discussed above.

Various embodiments of the present invention may exhibit one or more of the following objects, features and/or advantages:

(i) weatherseal that has improved performance characteristics;

(ii) improved cost efficiency weatherseal;

(iii) weatherseal with lower closing force and more designer control of closing force;

(iv) weatherseal that performs better in applications that extend around corners;

(v) weatherseal with improved performance in applications where there is high compression when the fenestration member is moved for cleaning operations;

(vi) reduced wear and tear on seal; and/or

(vii) reduced need to upgrade.

According to the present invention, a seal for use in a fenestration system is provided. The seal includes: a seal base; and an elongated, resilient bulb member defining a longitudinal direction and a transverse direction. The seal base and the resilient bulb member are rigidly mechanically connected to each other. The bulb member includes an exterior bulb wall and a first interior wall. The exterior bulb wall defines an interior space. The first interior wall separates and at least partially defines a first chamber and a second chamber within the interior space of the exterior bulb wall.

According to a further aspect of the present invention, a seal for use in a fenestration system is provided. The seal includes: a seal base; and a resilient bulb member. The seal base and the resilient bulb member are rigidly mechanically connected to each other. The bulb member includes an exterior bulb wall and a first interior wall. The exterior bulb wall defines an interior space. The first interior wall separates and at least partially defines a first chamber and a second chamber within the interior space of the exterior bulb wall. The first interior wall is sized and/or shaped so that its transverse cross-section is generally V-shaped and defines an apex.

According to a further aspect of the present invention, a fenestration system includes: a first fenestration structure; a second fenestration structure; a first chamber structure comprising a first resilient chamber-defining wall; and a second chamber structure comprising a second resilient chamber-defining wall. The first and second fenestration structures are mechanically connected to each other as a fenestration-frame-and-closure-member assembly. The first chamber structure is mechanically connected to and extends from the first fenestration structure. The second chamber structure is mechanically connected to and extends from the second fenestration structure. The first chamber structure is shaped so that its outer profile defines a recess. The second chamber structure is shaped so that its outer profile defines a protrusion. The first and second chamber structures are shaped and located so that the protrusion of the second chamber structure extends into and is mechanically connected to the recess of the first chamber structure.

According to a further aspect of the present invention, a seal for use in a fenestration system is provided that includes, but is not limited to: a seal base; an elongated, resilient bulb member defining a longitudinal direction and a transverse direction; wherein: the stem portion of the seal base and the resilient bulb member are rigidly directly mechanically connected to each other; the bulb member includes an exterior bulb wall with an interior surface, a first interior wall, and a second interior wall; the exterior bulb wall defines an interior space; the first interior wall and the second interior wall separate and at least partially define a first chamber, a second chamber, and a third chamber within the interior space of the exterior bulb wall.

### BRIEF DESCRIPTION OF THE DRAWINGS

The present invention will be more fully understood and appreciated by reading the following Detailed Description in conjunction with the accompanying drawings, in which:

FIGS. 1A and 1B are a transverse cross-sectional views (cross hatching omitted for clarity in this cross-section, and also some of the other cross-sections throughout the Figures, for clarity of illustration purposes) of a first embodiment of a weatherseal assembly according to the present invention;

FIG. 2 is a transverse cross-sectional view of a second embodiment of a weatherseal assembly according to the present invention;

FIG. 3 is a transverse cross-sectional view of a third embodiment of a weatherseal assembly according to the present invention;

FIG. 4 is a transverse cross-sectional view of a fourth embodiment of a weatherseal assembly according to the present invention;

FIG. 5 is another transverse cross-sectional view of a portion of the fourth embodiment assembly;

FIG. 6 is a transverse cross-sectional view of a fifth embodiment of a weatherseal assembly according to the present invention;

FIG. 7 is a transverse cross-sectional view of a sixth embodiment of a weatherseal assembly according to the present invention;

FIG. 8 is a transverse cross-sectional view of a seventh embodiment of a weatherseal assembly according to the present invention;

FIG. 9 is another transverse cross-sectional view of a portion of the fourth embodiment assembly;

FIG. 10 is a transverse cross-sectional view of a eighth embodiment of a weatherseal assembly according to the present invention;

FIG. 11 is a transverse cross-sectional view of a ninth embodiment of a weatherseal assembly according to the present invention;

FIG. 12 is a transverse cross-sectional view of a tenth embodiment of a weatherseal assembly according to the present invention;

FIG. 13 is a transverse cross-sectional view of a 11th embodiment of a weatherseal assembly according to the present invention;

FIG. 14 is a transverse cross-sectional view of a 12th embodiment of a weatherseal assembly according to the present invention;

FIG. 15 is a transverse cross-sectional view of a 13th embodiment of a weatherseal assembly according to the present invention;

FIG. 16 is a transverse cross-sectional view of a 14th embodiment of a weatherseal assembly according to the present invention;

FIG. 17 is a transverse cross-sectional view of a 15th embodiment of a weatherseal assembly according to the present invention;

FIG. 18 is a transverse cross-sectional view of a 16th embodiment of a weatherseal assembly according to the present invention;

FIG. 19 is another transverse cross-sectional view of the 16th embodiment of a weatherseal assembly according to the present invention;

FIG. 20 is a transverse cross-sectional view of a 17th embodiment of a weatherseal assembly according to the present invention;

FIG. 21 is a transverse cross-sectional view of a 18th embodiment of a weatherseal assembly according to the present invention;

FIG. 22 is another transverse cross-sectional view of the 18th embodiment of a weatherseal assembly according to the present invention;

FIG. 23 is a transverse cross-sectional view of a 19th embodiment of a weatherseal assembly according to the present invention;

FIG. 24 is another transverse cross-sectional view of the 19th embodiment of a weatherseal assembly according to the present invention;

FIG. 25 is a transverse cross-sectional view of a 20th embodiment of a weatherseal assembly according to the present invention;

FIG. 26 is another transverse cross-sectional view of the 20th embodiment of a weatherseal assembly according to the present invention;

FIG. 27 is a transverse cross-sectional view of a 21st embodiment of a weatherseal assembly according to the present invention;

FIG. 28 is another transverse cross-sectional view of the 21st embodiment of a weatherseal assembly according to the present invention;

FIG. 29 is a transverse cross-sectional view of a 22nd embodiment of a weatherseal assembly according to the present invention;

FIG. 30 is a transverse cross-sectional view of a 23d embodiment of a weatherseal assembly according to the present invention;

FIG. 31 is a transverse cross-sectional view of a 24th embodiment of a weatherseal assembly according to the present invention;

FIG. 32 is another transverse cross-sectional view of a 24th embodiment of a weatherseal assembly according to the present invention;

FIG. 33 is a transverse cross-sectional view of a 25th embodiment of a weatherseal assembly according to the present invention;

FIG. 34 is a transverse cross-sectional view of a 26th embodiment of a weatherseal assembly according to the present invention;

FIG. 35 is a transverse cross-sectional view of a 27th embodiment of a weatherseal assembly according to the present invention;

FIG. 36 is a transverse cross-sectional view of a 28th embodiment of a weatherseal assembly according to the present invention;

FIG. 37 is a transverse cross-sectional view of a 29th embodiment of a weatherseal assembly according to the present invention;

FIG. 38 is a transverse cross-sectional view of a 30th embodiment of a weatherseal assembly according to the present invention; and

FIG. 39 is a transverse cross-sectional view of a 31st embodiment of a weatherseal assembly according to the present invention.

FIG. 40 is a transverse cross-sectional view of a 32d embodiment of a weatherseal assembly according to the present invention.

### DETAILED DESCRIPTION OF THE INVENTION

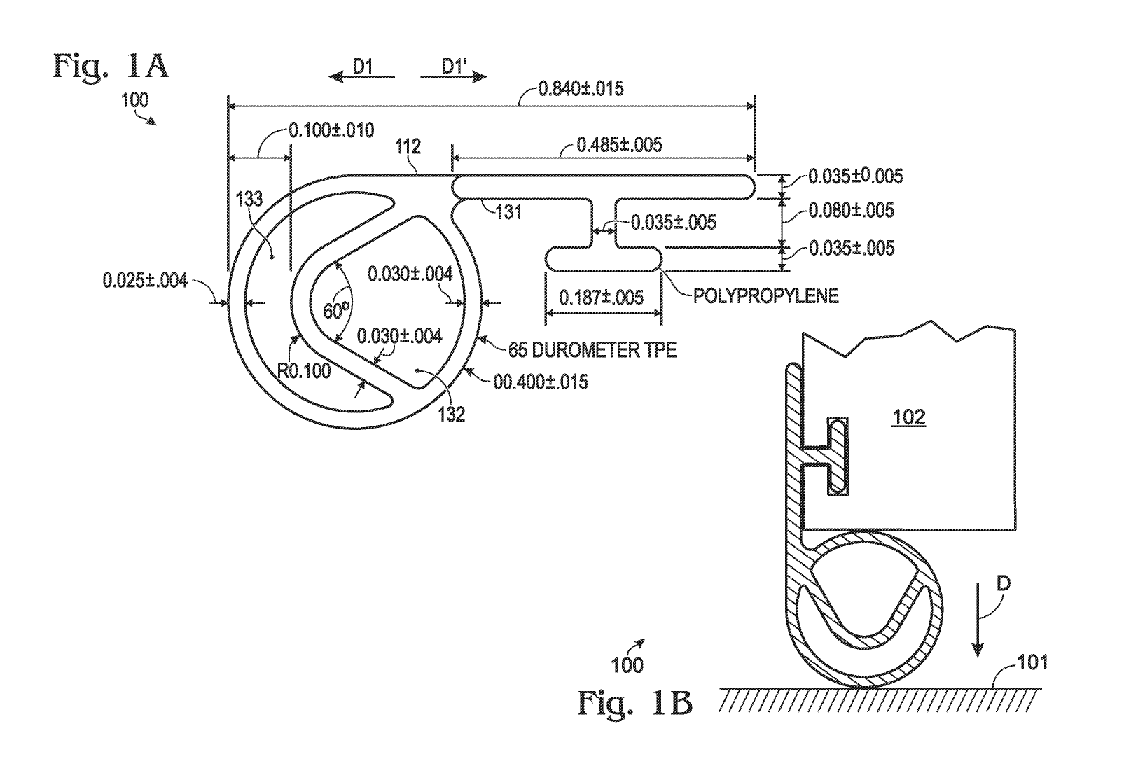

FIGS. 1A and 1B show a transverse cross-section of seal 100 including: bulb 112 (defining first chamber 132 and second chamber 133); and base 131.

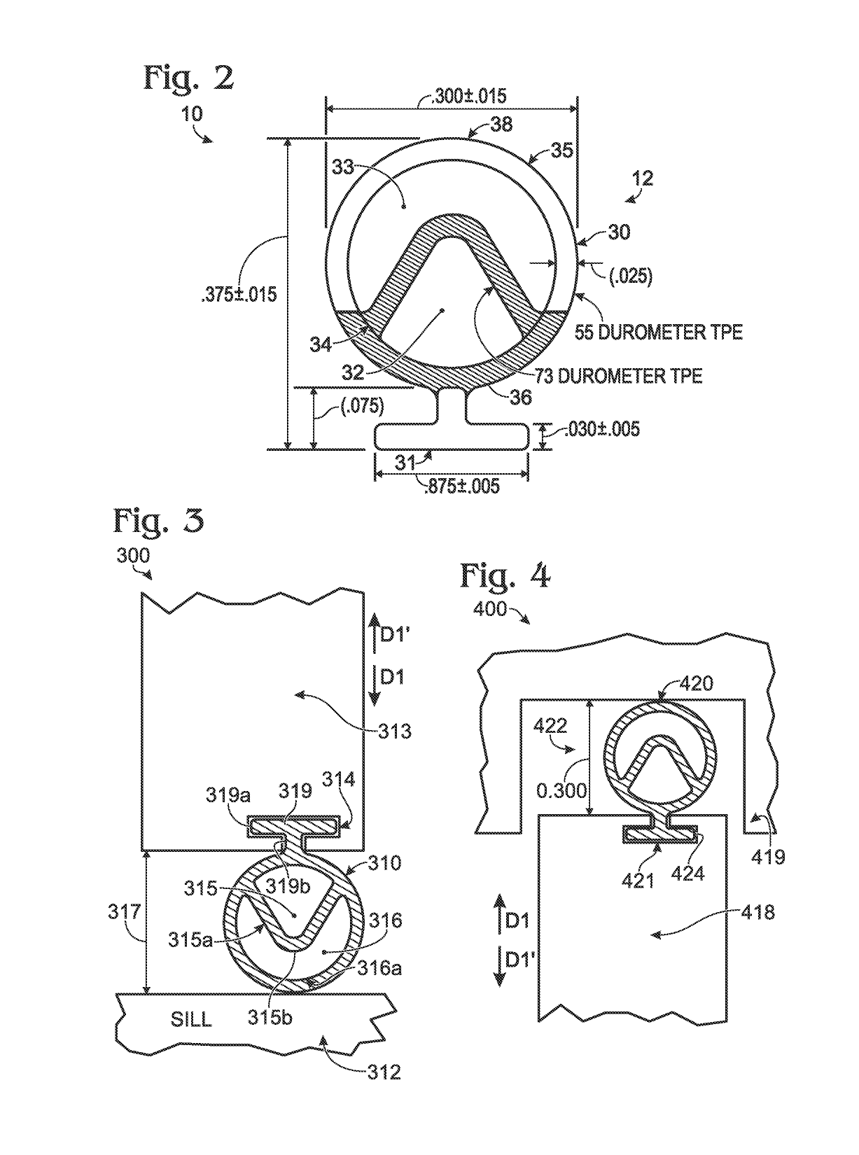

FIG. 2 shows a transverse cross-section of seal 10 including: bulb 12 (defining first chamber 32 and second chamber 33); and base 31.

As shown in FIGS. 1 and 2, seals 10 and 100 both include multiple-hollow-chamber bulbs having a first chamber and a second chamber divided by a generally V-shaped interior wall. In this document, “generally V-shaped” shall be taken to include geometries that are generally U-shaped. Also, the apex of the V-shape of the interior wall does not touch the inner surface of the cylindrical exterior wall of the bulb, at least when the bulb is in its fully expanded position as shown in FIGS. 1 and 2. Alternatively, the apex could extend to touch, or to be integrally connected with, the exterior bulb wall. Alternatively, the outer bulb wall may have shapes other than a cylinder, such as a hollow square-cross-section prism shape. However, the generally V-shaped interior wall of FIGS. 1 and 2 is currently preferred because it is believed to cause the two chambers to interact during and after the compression application in a manner that enhances performance characteristics of the seal.

In both of these seals 10 and 100, the first chamber is shaped as a protrusion and the second chamber is shaped as a recess, as shown in FIGS. 1 and 2.

FIG. 6 shows a fenestration system including: translating upper window sash 218; window frame 219; multiple hollow chamber bulb 220; and seal base 221. Weatherseals are designed to compress a specified amount to ensure proper sealing between window members as depicted in FIG. 6. As further shown in FIG. 6, by having the apex of the generally V-shaped interior wall 223 pointing in the direction D1 (which is the direction that the fenestration closure member moves relative to the fenestration frame as it moves from its open position into its closed position), or D1′ (which is the direction counter to D1), the apex will come into contact with the interior surface of the outer bulb wall as the bulb is compressed by its contact with the fenestration frame. In the embodiment of FIG. 6, the seal is “permanently” attached to the fenestration closure member, which is preferred because seals are generally less susceptible to damage when permanently attached to the closure member, rather than the fenestration frame. However, the seal and its bulb having an interior wall with an apex facing the closure or counter-closure direction would also work to enhance performance characteristics in a similar way if the seal is permanently attached to the fenestration frame.

As shown in FIG. 3, shows a double hung window fenestration system including: exterior bulb wall 310; fenestration frame 312; fenestration closure member 313; seal base receiving recess 314; first chamber 315; generally V-shaped interior wall 315a; second chamber 316; compression commencement gap dimension 317; and seal base 319. It is noted that it is the location and orientation at which bulb 310 is attached to base 319 that effectively defines directions D1 and D1′. For example, for a T-shaped base where the bulb is attached at the end of the vertical arm of the T-shape, the frame attachment arms 319a will generally be perpendicular to directions D1 and D1′ and the vertical arm 319b will face the D1 direction and face directly away from the D1′ direction. The means that apex 315b preferably should be aligned along the vertical arm 319b, pointing either directly away from it (as in system 300), or directly away from it. As shown in FIG. 1, other base-and-bulb geometries are possible and will serve to define other D1 and D1′ directions, which in turn will define preferred directions for the apex of the interior wall to point.

FIG. 3 depicts multi-hollow weatherseal 310 located between lower-sash 313 of double hung window 311 and window sill 312. Weatherseal 310 is held in place by t-slot retention groove 314. When the window is closed weatherseal 310 compresses approximately 20 to 30%. When compressed, weatherseal 310 provides a barrier against air and water infiltration. When weatherseal 310 is in its compressed position of 20% to 30% of the surface area of generally V-shaped interior wall 315a will contact the interior surface of exterior bulb wall 310. The apex 315b of interior wall 315a and the interior surface 316A of exterior wall 310 come into contact as the fenestration closure member is closed. This results in an increase in closing force as the seal reaches its compression range of 20% to 30%. This causes an increase in lip pressure between the exterior surface of exterior bulb wall 310 and sill 312. this increased lip pressure causes an increase in the seal's ability to maintain a seal even during severe wind driven rain and air.

It will now be explained why it is currently preferred to shape and size the bulb so: (i) the apex of the generally V-shaped interior wall does not touch the interior surface of the exterior bulb wall in the expanded state; and (ii) the apex does touch the interior surface of the exterior wall as the fenestration system is moved to the closed position so that the bulb is in its fully compressed state (for example 30% compression based on bulb diameter). As the closure member is being closed (that is, moved in the D1 direction relative to the fenestration frame) the apex does not immediately bear on the interior surface of the exterior bulb wall. This makes it easier for a user to continue closing the fenestration closure member as the exterior surface of the exterior bulb wall first comes into contact with the seal-receiving fenestration structure (which, in this example, is the window sill). For example, the bulb may be structured so that half of the total compression of the bulb (for example 15% of the 30% total compression based on fully expanded bulb diameter) will occur before the resilient apex bears on exterior wall of the bulb, thereby reducing closure force for this portion of the closure operation. However, at some point the apex will come into contact with the exterior bulb wall and will begin to exert D1′ direction force as it undergoes resilient deformation. For example, the bulb may be sized and shaped as the bulb compresses from 15% compression to 30% compression. This increased force improves closure because the fenestration closure member slows and loses inertia during the initial phase of closure and then slows at a faster rate during the last phase of closure operations. This gradually stepped up resistance to closure can: (i) help prevent the fenestration closure member from bouncing back up off of the frame when excessive force is being applied; and/or (ii) help a user more precisely control the closure force that she is applying during those crucial moments of time as the closure member is coming into contact with the fenestration frame. To expand on point (ii), the user is subtly encouraged to save the application of force until the very end of the closure procedure in order to prevent a build-up of excessive inertia in the closure member—which is to say, in common parlance, that the user will be less likely to slam shut the window or door.

With the expanded-position-not-touching/compressed position-touching geometry of the interior wall apex of preferred embodiments of the present invention, the weatherseal can be designed to have a very specific closing force by adjusting the relationship between how much of the compression takes place with the walls of the inner and outer bulbs compressing together. A preferred objective for designs according to the present invention is to balance the amount of closing force with the desired level of sealing or lip pressure that is required to eliminate air and water infiltration. Lip pressure or sealing pressure is the pressure that the seal exerts against the surface it is sealing to or against.

This invention provides for a more cost effective option as compared to a foam filled seal that has limitations in the area of high closing forces and water absorption. However, it is noted that in some embodiments of the present invention, the first and/or second chambers may be filled, or at least partially filled with foam, or other materials, such as compressible thermal insulation fibers. By filling the first chamber, the second chamber and/or additional chamber(s) with various types of material (such as thermoset and/or thermoplastic foam) it may be possible to: (i) further optimize the closing forces for ease of proper fenestration system closure operation; and/or (ii) enhance the thermal and/or sound abatement performance characteristics.

In the case of water absorption that is a characteristic of the widely used urethane foam seals, the multiple hollow options will not wick water like the open cell urethane foam does. Closed cell TPE foams do not absorb water but do have higher closing forces due to their closed cell foam structure. In order to overcome the higher closing forces most closed cell foam weatherseals used in window applications as depicted in FIG. 3. are now designed with a hollow configuration (albeit with no interior wall of any sort, much less an interior wall with an apex) in order to reduce closing forces. A hollow foam bulb seal offers less resilience than a solid foam structure eliminating one of the features of foam. The hollow foam also reduces the foam seals performance in the areas of thermal properties and sound abatement. When in he closed compressed state the multi hollow bulb technology of the present invention can create a cost effective seal with multiple walls and in turn multiple chambers that provide effective thermal and sound abatement properties.

Standard single hollow bulb seals do not offer the level of compression set resistance a foam filled bulb, but they do offer more acceptable closing forces and are more cost effective. The hollow chamber embodiments of the present invention can provide a higher performing seal through the use of the multiple hollow designs that have a lower closing force than foam-filled designs, once in compressed position (for example, 20% to 30% of functional height). As stated above, the exemplary compression percentages discussed herein are generally based upon the height of the bulb in its expanded position (see dimension 317 in FIG. 3).

Compression set resistance of the multi hollow seal exceeds traditional hollow bulb seals and meets the performance of most thermoplastic elastomer foam filled bulb seals offering a cost effective alternative. Once again, however, it will be mentioned that multiple chamber bulbs of the present invention may be filled or partially filled with foam and/or other materials, and this may lead to even better designs than the currently preferred hollow chamber designs discussed herein. Urethane or thermoset foam filled bulb seals may offer better compression set resistance but this is offset by the fact that the open cell nature of these foams absorb water which is what a seal designer generally tries to seal out and in a freeze thaw condition could result in damage to the window or door. The present invention tends to lower opening and/or closing forces relative to what is observed with conventional seal, and this is generally a good thing.

FIG. 2 depicts a multi-hollow bulb seal 10 with a standard t-slot base 31. This seal has a number of uses in current window and door designs and is one of the most common designs currently.

FIG. 4 shows double hung window fenestration system 400 including: upper sash 418; frame 419; bulb 420; t-slot retention groove 421; fully expanded height dimension 422; and T-shaped seal base 424. Seal 420,424 is held in position in t-slot retention groove 421. In FIG. 4 the window sash is depicted in the open position and bulb 420 is depicted in what is called full functional height indicated by dimension 422 (preferably 0.300 inches). In this embodiment, the fully expanded height is basically the height that the bulb extends above the sash when the sash is open, but this equivalence does not necessarily hold in all embodiments of the present invention. As those of skill in the art will appreciate, the bulb geometry should be designed with the geometry of the fenestration seal-bearing member and the fenestration seal-receiving member in mind so that the percentage of compression, and the point at which the apex of the interior wall comes into contact with the bulb exterior wall, is designed for optimal closure force pattern and for optimization of other performance characteristics.

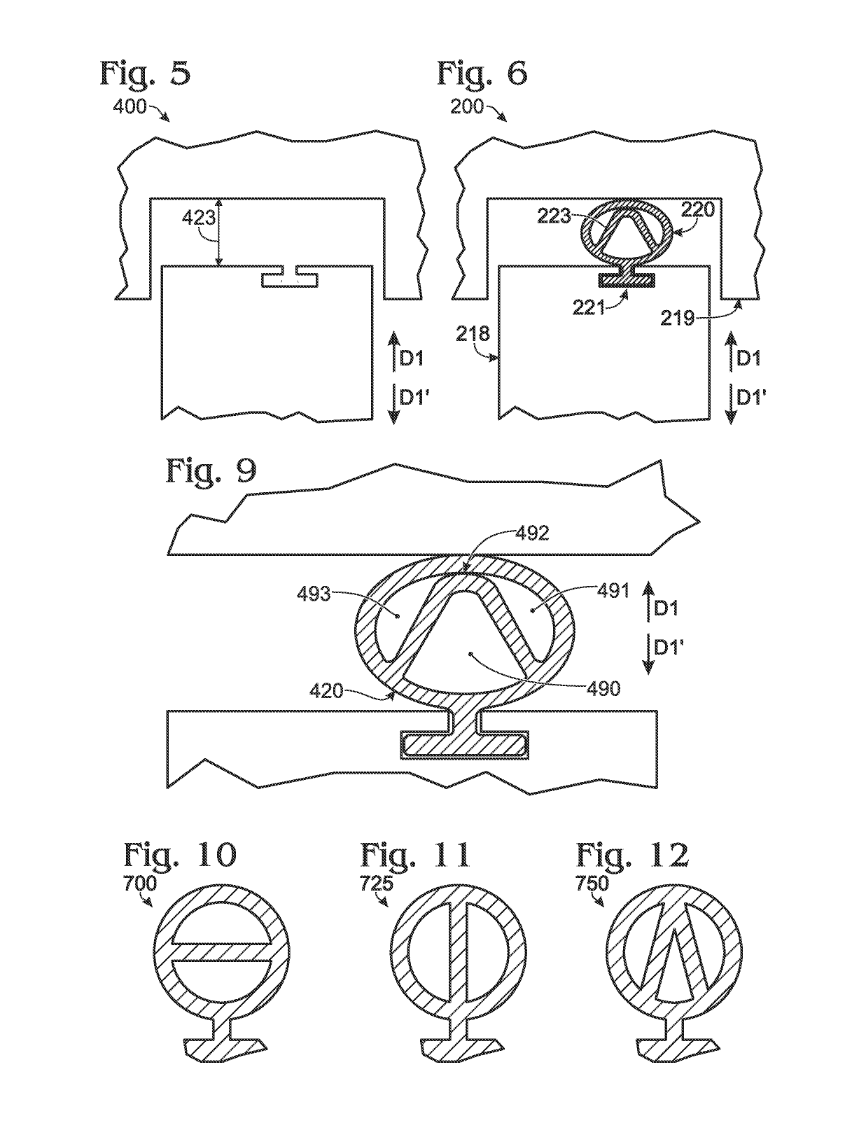

FIG. 5 shows fenestration system 400 without the seal installed, which configuration is useful to consider for system design purposes. As shown in FIG. 5, nominal gap 423 designed by the engineer is 0.225 inches. Dimension 423 represents the compressed height at which seal 420, 424 must create a barricade against air and water infiltration. As the top of the upper sash travels in the D1 direction from 0.300 inches from the frame to 0.225 inches from the top of the frame, the apex of the interior wall will come into contact with the exterior bulb wall and come to exert some portion of the closure force.

FIG. 6 shows fenestration system 400 when seal 420, 424 is in its compressed position. More specifically, in this embodiment of the present invention, full compression is 25% of the fully expanded bulb diameter and this is how much the bulb will be compressed when the fenestration closure member is in the closed position. To explain in numerical terms, 0.225 inches (that is, the fully compressed bulb height) is 75% of 0.300 inches (that is, the fully expanded bulb height. In the fully compressed position shown in FIG. 6, the desired seal between sash 218 and frame 219 is substantially created by the seal hardware. These dimensions may vary between fenestration system applications, but these typical dimensions should give some idea of the design imperatives typically involved in creating designs according to the present invention.

FIG. 9 shows that, in the compressed position of system 400, three chambers are effectively created inside the bulb as follows: (i) first chamber 490; (ii) first sub-chamber 493 of the second chamber; and (iii) second sub-chamber 491 of the second chamber. The creation of this multiplicity of chambers may enhance the thermal and/or sound abatement performance characteristics of the seal, similar to the manner in which a two-panel-with-airspace insulated glass window has improved thermal and/or sound abatement characteristics, but whatever the exact physics and/or mechanics of the seal are it is strongly believes that the multiplicity of chambers will cause batter thermal and/or acoustic sealing characteristics than a comparable hollow seal with only a single chamber. Reference number 492 represents the contacting surface area between the apex of the interior wall and the exterior bulb wall.

FIG. 2 shows a typical construction of a multi-hollow bulb seal. Multi hollow bulb 30 is attached to base 31 which is extruded from a polyolefin based thermoplastic that is compatible with the thermoplastic elastomer (TPE) or thermoplastic vulcanizite TPV) used to form walls 34 that make up internal bulb 32 and external bulb 33. The two materials are compatible on a polymer basis due to the fact the TPE or TPVs used are constructed of a matrix of polyolefin based material and fine particles of thermoset rubber typically EPDM rubber. The polyolefin portion of this matrix allows the polymer to process like a thermoplastic and enables the co-extrusion to a polyolefin based material that typically is polypropylene. The rubber portion of the matrix that makes up a TPE or TPV results in the bulb having mechanical properties like a thermoset rubber. The percentage of thermoplastic (for example, PP or PE) compared to the amount of rubber particles blended into the polymer matrix results in whether the TPE/TPV material will be harder or softer or related differently, act more or less like a rubber.

Also an option that can be added to this multi-hollow seal is the co-extrusion of low friction polyolefin based material 35 on the external surface of external bulb 33 that will be in contact with the mating surface of the window or door. This low friction material 35 would exhibit a lower coefficient of friction than the TPE or TPV used in wall 34 of external bulb 33. A lower coefficient of friction would result in a seal designed for applications that might require a sliding or tilting operation that would otherwise generate extensive friction with a typical TPE or TPV. TPE and TPVs come in different durometers and are typically measured on a shore “A” or a Shore “D” scale. Shore “A” TPE/TPVs come in a typical useful range of 30 to 90 and the lower the number the softer the material is. Shore “D” materials are harder and are typically utilized in designs that require materials over 90 on a Shore “A” scale. The useful range of Shore “D” materials is 30 to 60 to make weatherseals and there uses are limited to rigid members that Shore “A” materials can be coextruded to or as a lower friction material that can be coextruded to the outside of bulb seal 34 to reduce friction when the seal contacts mating surfaces during the opening and closing of the window or door resulting in a reduction of operating force required to be exerted by the consumer.

FIG. 8 shows seal 500 including: exterior bulb wall 574; interior surface of exterior bulb wall 571; second chamber 572; first chamber 570; generally V-shaped interior wall 578; and apex 573. First chamber 570 is strategically sized, shaped and/or located so that during compression (window or door is closed), interior surface 571 of outer bulb 572 contacts apex 573 of interior wall 578. The distance of the spacing between the apex and the interior surface of the exterior bulb wall, in the fully expanded bulb position, is carefully designed to optimize performance characteristics as described above in connection with previous embodiments. A weatherseal is typically compressed 20% to 30% and the goal is to achieve this compression range without excessive closing force but still achieving an acceptable pressure between the resilient outer wall 574 and resilient interior wall 578. This closing force can be changed by adjusting the space between the interior wall apex and the exterior bulb wall. For example if a designer wants a lower closing force she will increase the space between these components. A preferred range of compression percentages is 15% to 40%. A preferred sub-range within that range is 20 to 30%.

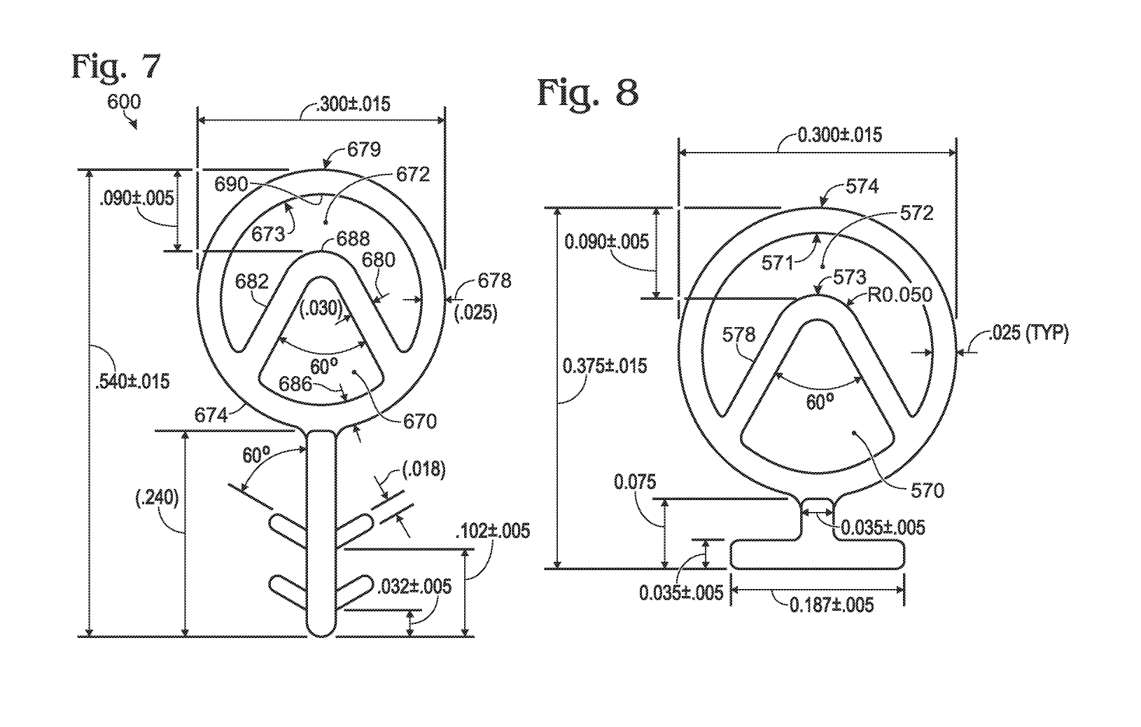

FIG. 7 shows push-in type multiple hollow chamber seal 600 including: first chamber 670; second chamber 672; seal-receiving side portion of exterior bulb wall 673; seal-bearing side portion of exterior bulb wall 674; seal-receiving side exterior wall thickness 678; interior wall thickness 680; generally V-shaped interior wall 682; and seal-bearing side exterior wall thickness 686. Seal 600 demonstrates that another approach that can be used to increase or decrease closing forces is to change wall thickness 680 of interior wall 682 relative to seal-receiving side exterior bulb wall thickness 678. If exterior bulb wall 674 is extruded to have a seal receiving side exterior bulb wall thickness lower than interior wall thickness 680 then the result will be a lower closing force until the interior wall's apex 688 makes contact with the interior surface 690 of the exterior bulb wall. After compression is sufficiently progressed to cause contact by the apex, the force will build quickly due to the thick interior wall being resiliently deformed through force transmitted by the fenestration structures through the seal-receiving portion of the exterior bulb wall. It is further noted that the thickness 686 of the bottom portion of the exterior bulb wall can be varied independently of thicknesses 678 and 680 to help optimize performance characteristics. As shown in FIG. 7, the fully closed position of the window has a gap of 0.225 inches. This means that a 0.300 outer diameter bulb will undergo 25% compression (with part of this compression occurring before the V-shaped interior wall is brought to bear, and part of this compression occurring after the interior wall comes into contact with the exterior bulb).

The seal base of the seal of FIG. 7 is push-in casement style and is suitable to wrap around corners. As mentioned above, one feature of some embodiments of the present invention is superior performance in corner wrap around applications. Unlike hollow bulb seals with no interior wall, the hollow bulb embodiments of the present invention will maintain a good degree of structure integrity in the vicinity of the corner and will not tend to completely collapse in the vicinity of the corner. Unlike foam-filled seals, the hollow bulb embodiments of the present invention are not subject to the problem of foam-filled seals where material builds up in the bend at the corner, thereby creating an unwanted high point on the sealing plane.

FIG. 2 depicts another embodiment with wall 34 of outer bulb 33 being made from three different materials as follows: (i) Shore “A” 73 durometer tpe for interior wall 34; (ii) Shore “A” 55 durometer tpe for a first portion of the bulb 35; and (iii) Shore “A” 64 durometer tpe for a second portion of the bulb 36. The use of different durometers can be used to increase or decrease closing forces allowing engineers to tune in the multi-hollow bulb seal for the desired closing force for the window or door. In some preferred embodiments, the three different material portions are attached because they are co-extruded by cross head extrusion. This is feasible because the three different materials are all tpe. If other materials are used (such as dissimilar materials), then the portions of different material may be connected to each other in different ways, such as by adhesive.

The primary goal with many of the described embodiments is to reduce closing forces, increase sealing pressure (lip pressure), decrease compression set over time, improve long term resiliency, and improve sound abatement and thermal properties over pile or standard hollow and foam filled bulb seals due to the strategically placed walls of the multiple hollow design of the seal. The multi-hollow bulb seal embodiments of the present invention allow the window or door designer to better strike an optimal balance between performance and cost, and to improve bottom line energy efficiency for the fenestration system (e.g., window).

FIG. 10 shows another embodiment of a seal 700 according to the present invention.

FIG. 11 shows another embodiment of a seal 725 according to the present invention.

FIG. 12 shows another embodiment of a seal 750 according to the present invention.

FIG. 13 shows another embodiment of a seal 775 according to the present invention including: interior spaces 776,777,778,779; and wall segments 780,781,782,783. A couple of points on terminology used in this document will now be explained in connection with this seal embodiment. First is that “chamber” is a term that has some flexibility. For example: (i) seal 775 may be considered to have four chambers, with one chamber respectively corresponding to each interior space 776,777,778,779; or (ii) seal 775 could be considered to have two chambers, one corresponding to interior space 776 and the other corresponding to interior spaces 777,778,779 and wall segments 782,783; or (iii) seal 775 could be considered to have three chambers, one corresponding to interior space 776, another corresponding to interior space 779 and the their chamber corresponding to interior spaces 778,789 and wall segment 783; or (iv) there are many other ways to count the “chambers” in accordance with the principles of the previous three examples. In other words, a “chamber” can be divided into mutually exclusive compartments, or each compartment can be considered as a “chamber.” In this document, the word “chamber” is used to mean either of these sorts of chambers (sub-divided or not). Now, while seal 775 can be validly described as having one, two, three or four chambers, it is noted that it does not have five chambers. A “chamber” must have at least one interior space (hollow or filled), in order to support the designation. More definitional assistance for the term “chamber” is in the DEFINITIONS section. Another set or related terms that has some flexibility in their usage are the terms “wall” and “interior wall.” Generally speaking, the term “wall” is used to mean a generally flat and generally continuous solid (for example, not foam) surface, but the surface can have bends, curves, resiliency, discontinuities, non-uniform thickness and the like. Also, a portion of a “wall” may also properly be called a “wall,” so long as it is clear what portions of the flat body are being referred to. For examples: (i) wall segment 780 can be considered as an “interior wall;” (ii) wall segments 780 and 782 can be considered as an “interior wall;” (iii) wall segments 780 and 781 can be considered as an “interior wall;” (iv) the lowermost X degrees arc of exterior bulb wall 784 can be considered as a “wall” (but not an “interior wall”).

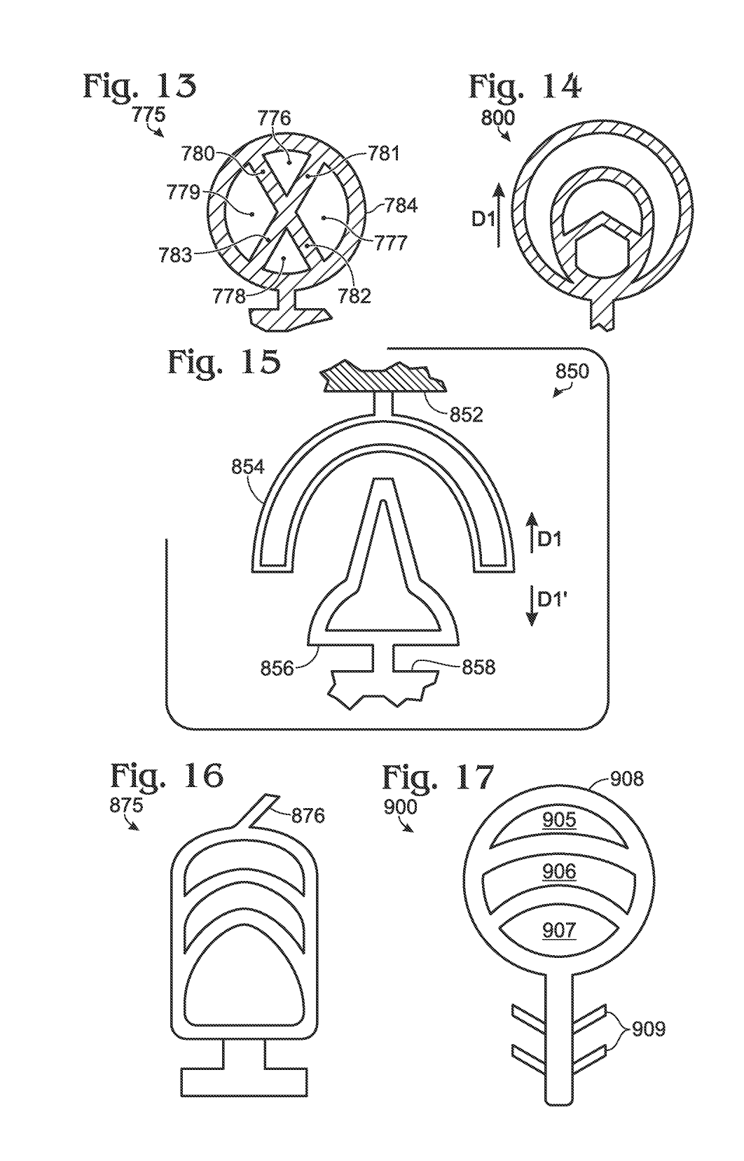

FIG. 14 shows another embodiment of a seal 800 according to the present invention.

FIG. 15 shows fenestration system 850 according to the present invention including: fenestration frame 852; frame-side bulb 854; closure-side bulb 856; and fenestration closure member 858. This embodiment is fundamentally different from the previously-discussed embodiments in that one chamber is permanently mechanically connected to the fenestration frame and the other chamber is permanently mechanically connected to the fenestration closure member. This embodiment is similar to the previously-discussed embodiments in that one chamber is shaped as a protrusion with a generally V-shaped defining wall and the other chamber is shaped as a recess. As the fenestration is forced into the closed position the deformation and closure forces will be generally similar (and similarly advantageous) to the previously discussed embodiments.

FIG. 16 shows a transverse cross-section of another seal 875 according to the present invention. Seal 875 includes extending flap 876. The use of the extending flap will help control the range of motion of the fenestration closure member that is subject to contact with, and physical resistance from, the seal. It is another type of device that can help control closing force as a function of the exact position of the fenestration closure member as it gets close to being fully closed.

FIG. 17 shows a transverse cross-section of another seal 900 according to the present invention. Seal 900 includes three chambers 905, 906 and 907 and flex bevels 909 (for retention of the weatherseal in the fenestration frame).

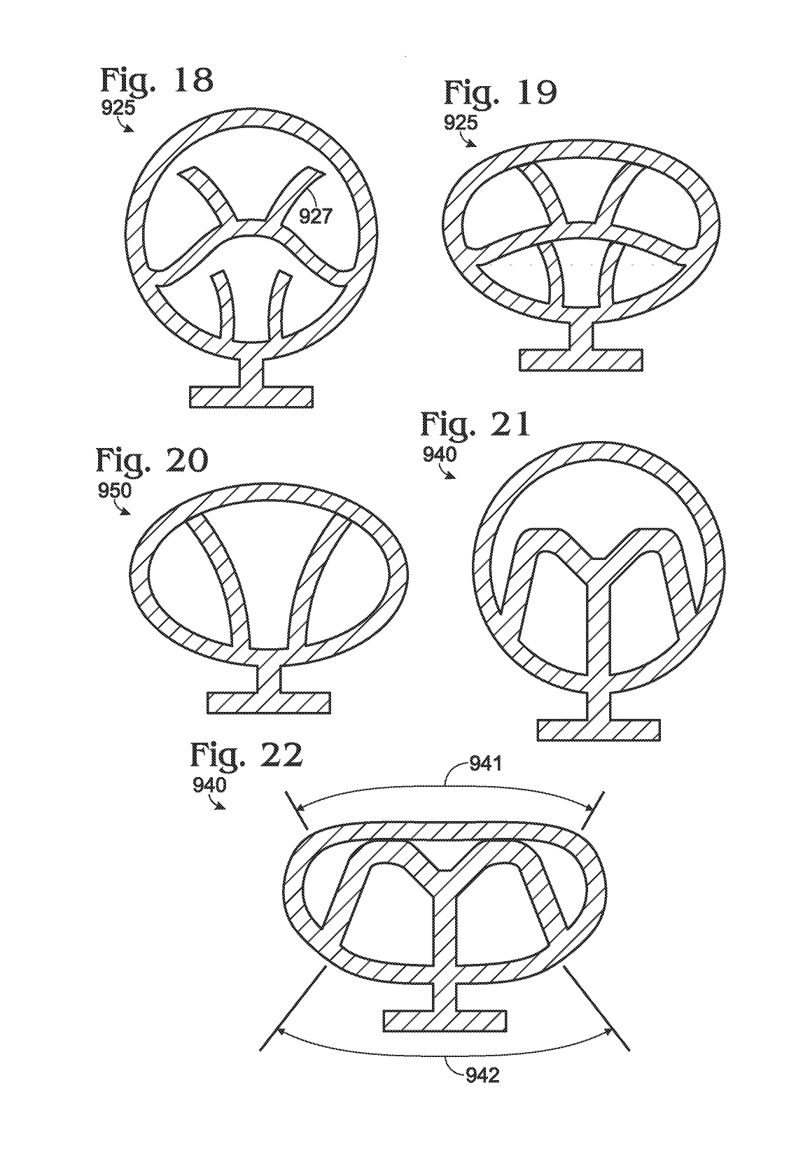

FIGS. 18 and 19 show a transverse cross-section of another seal 925 according to the present invention. As shown in FIG. 18, internal support flaps 927 will act like support columns, under axial compression, when the seal is in its closed state. As shown in FIG. 19, these flaps cause the number of internal chambers to increase from two to six in number when the fenestration closure member is closed.

FIG. 20 shows a transverse cross-section of another seal 950 according to the present invention, along with explanatory comments. FIG. 20 shows this seal in its closed position where two separate interior walls form three chambers. In its open state the interior walls do not extend all the way across the interior space of the bulb, so in the open state there is only one chamber. This brings up the important point that multiple chambers are considered to exist, for purposes of this document, even if they exist only in the closed state. Another important point to note is that seal 950 is considered to define multiple chambers (in the closed state), even though the interior walls only touch the interior surface of the bulb at one of their ends, and are not rigidly mechanically connected to the interior surface of the bulb. This mere touching is sufficient to define a “chamber” for purposes of this document.

The interior wall may be made thicker than it is in the currently-preferred design. It is possible that this would be advantageous for some applications. The inner could be modified to allow the interior wall to generate more force against the outer wall or in turn the item the seal is sealing against.

The interior walls could be made much thinner than the exterior bulb wall thinner and also multiplied in number to create a great multiplicity of chambers, for example, a honeycomb pattern of small chambers, a spider web pattern of small chambers. However, given current techniques, it is believed that proper control and maintaining of dimensions would make these type of designs cost prohibitive at least for most applications. Any thickness below 0.015″ is tough to control. Still, as techniques and/or materials improve over time, these embodiments of the present invention may become more practical. FIG. 40, discussed below shows the type of embodiment discussed in this paragraph.

The interior wall could be made substantially thicker than it is in the above-described embodiments. This would allow the interior wall to generate more force against the outer wall or in turn the item the seal is sealing against.

Many additional geometries for multiple hollow weatherseals according to the present invention will now be discussed in an extremely brief form. As those of skill in the art will recognize, these embodiments share many common features, such as having multiple hollows within the interior space of the “bulb” of a weatherseal assembly. As mentioned above, these multiple hollows: (i) may always be present whether or not the associated fenestration assembly is in its open or fully shut position; or (iii) may only form as the bulb is compressed from the open position towards the fully shut position by the closing of the fenestration member relative to the fenestration frame.

Turning now to FIGS. 21 and 22, weatherseal assembly 940 including dimensions 941 and 942. In this embodiment, there are three hollows when the fenestration assembly is open and the bulb is therefore uncompressed. As shown in FIG. 22, as the bulb compresses, “horizontal” dimensions 941 and 942 will increase in magnitude as the bulb compresses and flattens out along the vertical direction. At the same time, the “vertical” height (no separate reference numeral) of the bulb decreases. As shown in FIG. 22, this compression causes the uppermost hollow chamber to be sub-divided into three hollow chambers, so that the compressed bulb in the assembly 940 will have 6 total hollows that are mutually separated by substantially non-compressible bulb wall type material(s).

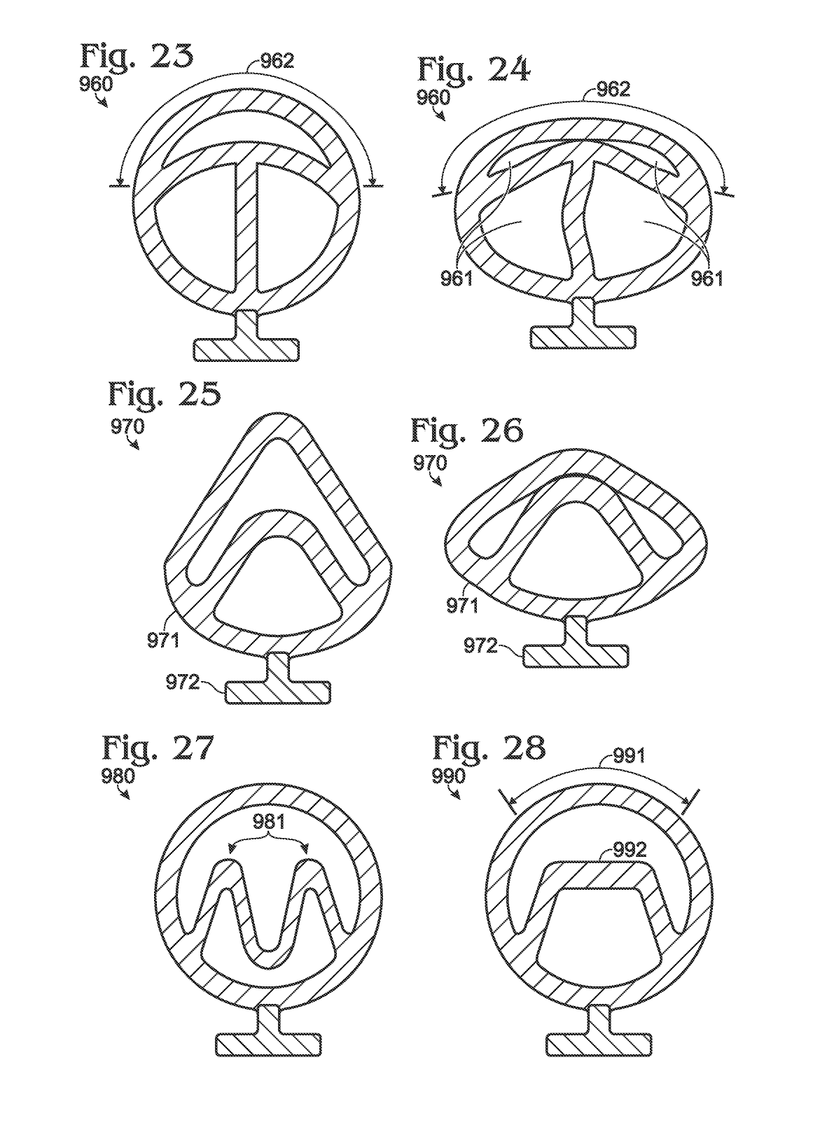

Turning now to FIGS. 23 and 24, weatherseal assembly 960 including multiple interior hollows 961. As shown in FIG. 24, continuous outer wall section 962 extends around approximately 180 degrees around the angular direction defined by the elongated weatherseal and the central axis of its bulb. Continuous outer wall 962 is characterized as “continuous” because it is not interrupted in its run by permanent, rigid junctures with the interior walls of the bulb. In some preferred embodiments there will be at least a 90 degree continuous run of outer wall about the “top” of the bulb (that is the part of the bulb extending furthest toward the fenestration member). In assembly 962, the continuous run is symmetrical about the “top” or zero degree angular position. This is preferred, but not necessarily required. It is even more preferred (at least for some applications) to have a continuous run of at least 120 degrees. It is even more preferred (at least for some applications) to have a continuous run of at least 180 degrees, as shown best by FIG. 23.

Turning now to FIGS. 25 and 26, weatherseal assembly 970 including exterior bulb wall portion 971 and base 972. In this embodiment, the geometry of the exterior and interior walls of the bulb is such that when the fenestration member (not shown) is shut to compress the exterior bulb wall: (i) an “upper” hollow will be compressed transversely so that it sub-divides into two separate hollows; and (ii) the lower hollow is not substantially compressed. As mentioned above, the interior bulb wall in an embodiment like this may be made of a polymer that is different from, and more rigid than, the material used for the exterior wall. In this way: (i) the portions of the bulb walls that need to compress will be easy to compress (for example, when a user closes a window); and (ii) the portions of the bulb that do not need to be compressed can be made of stiffer polymer (which, in some cases will have superior sound, thermal, moisture, wind resistance and/or otter favorable weatherseal properties.

Turning now to FIG. 27, weatherseal assembly 980 including undulating interior bulb wall 981. More specifically, interior wall 981 has a “two hump design.” Other undulating wall embodiments of the present invention may have tree, or even more, humps. In the two hump design of FIG. 27, there will come into existence three contact points between the inner and outer bulb walls as the bulb is compressed. As mentioned above, this means that it will be relatively easy to compress the bulb as it is first incrementally compressed from its at-rest state. However, after the contact points come into existence, the flexible interior bulb wall itself will tend to resist further incremental compression. This is potentially advantageous because it looks to a secure, reliable, and user-comfortable closing motion.

Turning now to FIG. 28, weatherseal assembly 990 including exterior wall contact range 991 and flat portion 992. As bulb 990 is compressed, the flat portion will come into contact with the exterior wall over a substantial angular range 991. This can be a beneficial geometry for some applications.

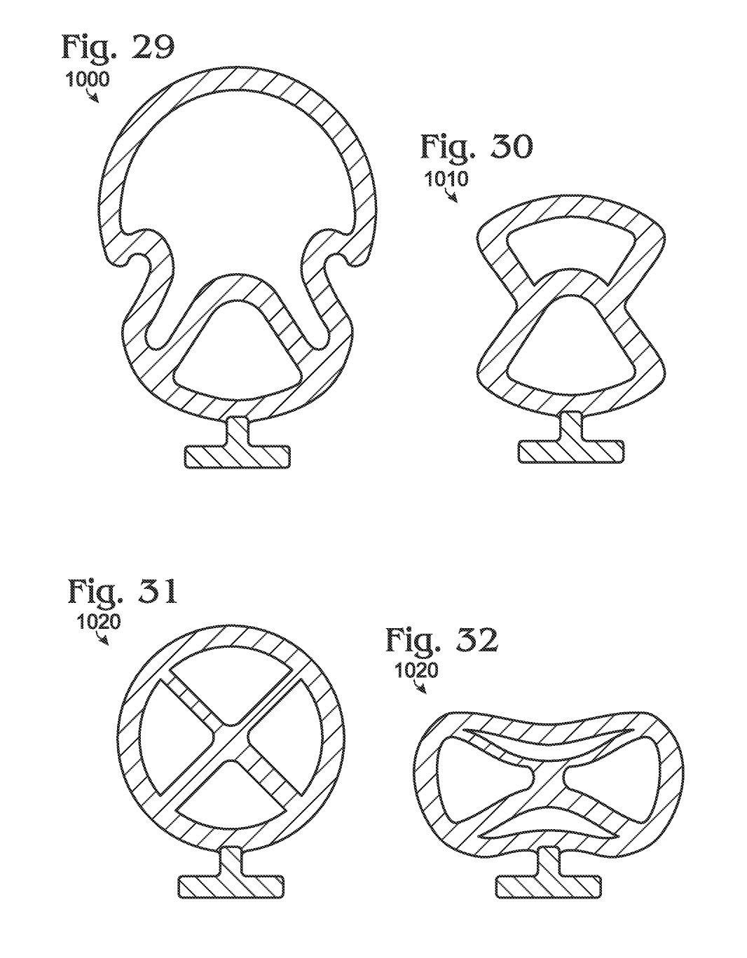

Turning now to FIG. 29, weatherseal assembly 1000. Note the undulating exterior bulb wall, which is no longer shaped as a cylinder, but rather has a more complex transverse exterior “footprint.” In these kinds of embodiments, physical interference between portions of the exterior bulb wall (that is, specifically where it undulates) can help increase required compression force so that compression force increases as the bulb compresses. In some previous embodiments, this increasing force requirement, that is built into the very design of the bulb, came from interferences between the interior and exterior bulb walls. But, these kinds of bulb-compression-induced interferences can be between portions of the exterior wall and/or between portions of a single interior wall (preferably an undulating interior wall that is shaped for its purpose).

Turning now to FIG. 30, weatherseal assembly 1010 is shown as a further embodiment of the present invention having a novel geometry.

Turning now to FIGS. 31 and 32, weatherseal assembly 1020 is shown as a further embodiment of the present invention having a novel geometry.

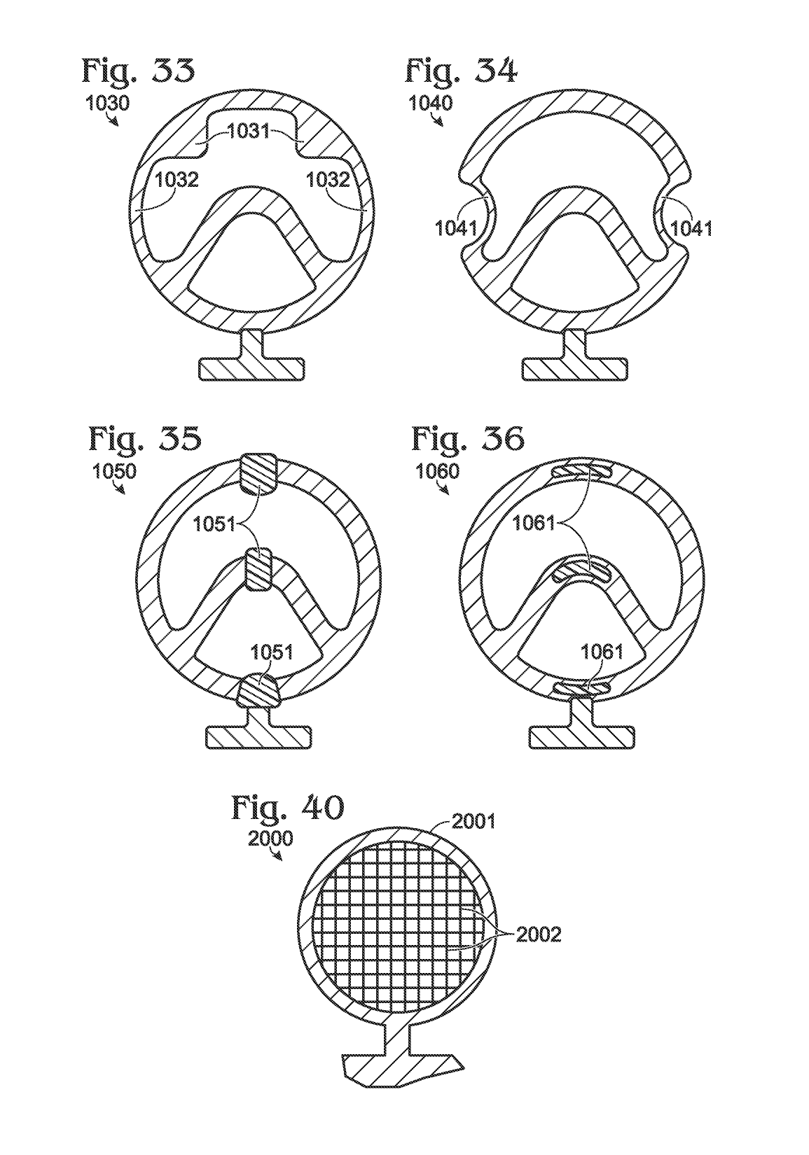

Turning now to FIG. 33, weatherseal assembly 1030 includes thick exterior bulb wall portions 1031; and tin wall portions 1032. The thick portions are present to help ensure proper alignment when the bulb is in its compressed position and the thick portions are in contact with portions of the interior bulb wall. Thin wall portion 1032 controls the specific area to flex.

Turning now to FIG. 34, weatherseal assembly 1040 includes thin exterior wall portions 1041. The thin wall portions control where the folding happens during compression.

Turning now to FIG. 35, weatherseal assembly 1050 includes wall portions 1051. Wall portions 1051 are made of a low thermal conductive material for improved thermal performance of the bulb assembly. Turning now to FIG. 36, weatherseal assembly 1060 includes wall portions 1061. Wall portions 1061 are made of low thermal conductivity material, like the similar portions discussed above in connection with embodiment 1050. Unlike embodiment 1050, the portions 1061 of embodiment 1060 are completely embedded within the exterior and/or interior wall(s) of the bulb.

Turning now to FIG. 36, weatherseal assembly 1060 includes low thermal portions 1061, which are “skinned over” as shown in FIG. 36.

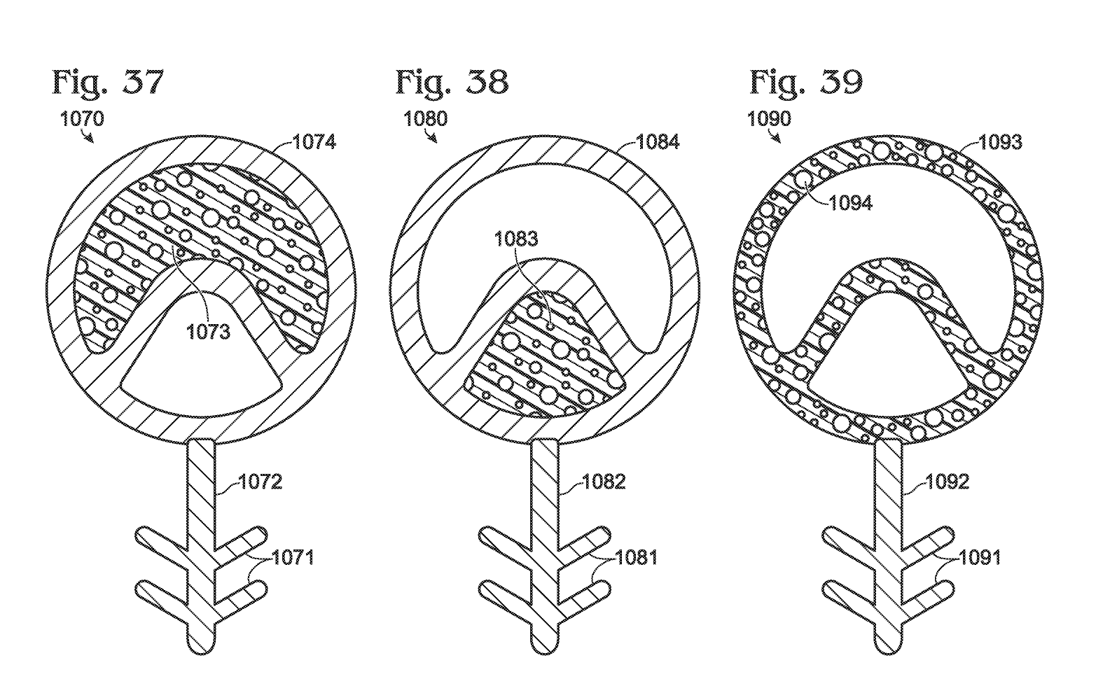

Turning now to FIG. 37, seal assembly 1070 includes multi-hollow TPE bulb 1074; foam filling 1073 (preferably thermoset or thermal plastic); polypropylene stem 1072; and TPE barbs 1071. It is noted that one of the “chambers” is not hollow here, but, rather, filled with filling 1073.

Turning now to FIG. 38, seal assembly 1080 includes multi-hollow TPE bulb 1084; foam filling 1083 (preferably thermoset or thermal plastic); polypropylene stem 1082; and TPE barbs 1081. It is noted that one of the “chambers” is not hollow here, but, rather, filled with filling 1083.

Turning now to FIG. 39, seal assembly 1090 includes multi-hollow TPE bulb 1093 (made of foam material 1094); polypropylene stem 1092; and TPE barbs 1091. See the definitions of “chamber” and “wall” in the DEFINITIONS section, because these words are used in a certain, and very particularly defined sense in this document.

FIG. 40 shows seal assembly 2000 including thick wall 2001 and a multiplicity of thin wall segments 2002. To the extent that extrusion and/or other enabling technologies allow such thin walls to be made, a single bulb may come to have a great number of chambers, but this is still to be sharply distinguished from, and not to be confused with foam (which has highly irregular cavities defined by solid foam portions that cannot be properly be called “walls”).

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: mechanical connections include force fit mechanical connections (as when a compressible seal is firmly compressed against a seal-receiving fenestration structure), as well as substantially rigid mechanical connections (such as when a seal base is attached to a seal-bearing fenestration member); “mechanical connections” includes both direct mechanical connections, and indirect mechanical connections made through intermediate components; includes rigid mechanical connections as well as mechanical connection that allows for relative motion between the mechanically connected components; includes, but is not limited, to connections formed by co-extrusion; welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

rigidly mechanically connected: substantially rigid, but may allow for some “play;” for example, connections between seal bases and the fenestration structures to which they are mounted generally have some play, but are still considered as “rigidly mechanically connected” for purposes of this document.

seal base: in some applications, a window sash, or other portion of a fenestration member may act as a seal base without the need for an intermediate piece part between the fenestration member and the bulb portion of the seal.

chamber: an interior space defined by “walls” (see DEFINITIONS section) and at least substantially enclosed; chambers will run longitudinally over at least some substantial portion of a seal, but their cross-section is not required to be uniform and they are not necessarily required to run along the entire length of the seal; while a “chamber” may include a wall, or a portion of a wall within its interior space, if the entire space is occupied by solid “wall,” then it is not a chamber; a chamber can be filled substantially up with foam or fibers or other non-solid materials so long as the material in the chamber is substantially less dense and substantially more compressible that the material of the walls that define the chamber; if a chamber is compressed so that it completely collapses then it is still considered as a chamber so long as the interior space can be restored (for example, by opening a closed fenestration system); the interior space of a chamber may be very small in cross-section, but irregular cavities like those found in porous foam are not to be considered as “chambers.”

Wall: a member or portion of a member that has substantially greater density and substantially less compressibility than whatever is located in the chambers that the wall defines, or helps to define; a wall can be made of foam, so long as it encloses a chamber filled with material less dense and more compressible than the foam of the wall; the material inside of a chamber will often simply be ambient atmospheric air, but FIGS. 37 and 38 show that chambers can be filled with foam, so long as the foam is substantially less dense and substantially more compressible than the wall material (which is TPE in FIGS. 37 and 38); the definition of “wall” is not limited to the definition provided above, as the embodiment of FIG. 39 shows that walls can be made of foam (material with a great multiplicity of irregular cavities), but in order for a chamber to be formed, the material inside the chamber (in the case of FIG. 39 this filler “material” is simply ambient air) must be more dense and less compressible than whatever is inside of the chamber.

member: may be integrally and unitarily formed from a single material, but is not limited to being integrally and unitarily formed from a single material.

fenestration products: include, but are not necessarily limited to residential doors, doors for business buildings, residential and non-residential windows (so long as the window is capable of opening and closing in some way), fast food windows, photocopiers with opening and closing lids and/or compartments; business products with compartments that open (usually through swinging or sliding “doors”), automobile doors, automobile windows, hinged or sliding solar panels, etc.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A seal for use in a fenestration system, the seal comprising:
a seal base;
an elongated, resilient bulb member defining a longitudinal direction and a transverse direction;
wherein:
the stem portion of the seal base and the resilient bulb member are rigidly directly mechanically connected to each other;
the bulb member includes an exterior bulb wall with an interior surface, a first interior wall, and a second interior wall;
the exterior bulb wall defines an interior space;
the first interior wall and the second interior wall separate and at least partially define a first chamber, a second chamber, and a third chamber within the interior space of the exterior bulb wall.

2. The seal of claim 1, wherein said exterior bulb wall is substantially circular.

3. The seal of claim 1, wherein said seal base is substantially T-Shaped comprising a stem portion and a cross section.

4. The seal of claim 3, wherein said stem portion and a cross portion are substantially perpendicular to each other.

5. The seal of claim 3, wherein each of the first interior wall and the second interior wall comprise a first end that contacts the interior surface at first positions adjacent to and on opposite sides of said stem portion.

6. The seal of claim 5, wherein each of the first interior wall and the second interior wall comprise a second end that extends away from said first end and contacts the interior surface at different second positions.

7. The seal of claim 1, wherein the first chamber and the second chamber are both hollow.
